(19) United States
(12) Patent Application Publication
(10) Pub. No.: US 2026/0343103 A1
(43) Pub. Date: Oct. 29, 2026

(54) CONTROL APPARATUS, IMAGE PICKUP APPARATUS, ILLUMINATION SYSTEM, CONTROL METHOD, AND STORAGE MEDIUM

(71) Applicant: CANON KABUSHIKI KAISHA, Tokyo (JP)

(72) Inventors: HIDEKI DOBASHI, Kanagawa (JP); KEIICHIRO SAITO, Tokyo (JP); YOSHIRO ICHIHARA, Kanagawa (JP); KEI TOHYAMA, Kanagawa (JP)

(21) Appl. No.: 19/645,975

(22) Filed: Apr. 13, 2026

(30) Foreign Application Priority Data
Apr. 23, 2025 (JP) 2025-071038

(51) Int. Cl. H04N 23/74; H04N 23/63

(52) U.S. Cl. CPC H04N 23/74; H04N 23/633; H04N 23/634

(57) ABSTRACT

A control apparatus for controlling an illumination apparatus by communication and for displaying an image may include one or more memories storing instructions, and one or more processors that, upon execution of the instructions, operate to acquire position information and setting information of the illumination apparatus via communication, and display, on a display unit, an image processed in accordance with the position information and the setting information.

### BACKGROUND

### Field of the Technology

The present disclosure relates to a control apparatus, an image pickup apparatus, an illumination system, a control method, and a storage medium.

### Description of the Related Art

Conventionally, it is known that an illumination apparatus is used to obtain an effect of reducing or eliminating shadows caused by natural light incident on an object, or to obtain a lighting effect by irradiating colored illumination light, etc.

Japanese Patent Application Laid-Open No. 2015-201839 discloses an image processing method that performs lighting processing on image data displayed on a display screen using virtual illumination.

### SUMMARY

A control apparatus according to one aspect of the present disclosure for controlling an illumination apparatus by communication and for displaying an image may include one or more memories storing instructions, and one or more processors that, upon execution of the instructions, operate to acquire position information and setting information of the illumination apparatus via communication, and display, on a display unit, an image processed in accordance with the position information and the setting information. An image pickup apparatus and an illumination system each including the above control apparatus also constitute another aspect of the present disclosure. A control method corresponding to the above control apparatus also constitutes another aspect of the present disclosure. A storage medium storing a program that causes a computer to execute the above control method also constitutes another aspect of the present disclosure.

Features of the present disclosure will become apparent from the following description of embodiments with reference to the attached drawings. The following description of embodiments will be described by way of example.

### BRIEF DESCRIPTION OF THE DRAWINGS

FIG. 1 is an explanatory diagram of an imaging system according to a first embodiment.

FIGS. 2A, 2B, 2C, and 2D are external configuration diagrams of an image pickup apparatus and an illumination apparatus according to the first embodiment.

FIGS. 3A and 3B are block diagrams of the image pickup apparatus and the illumination apparatus according to the first embodiment.

FIGS. 4A and 4B are explanatory diagrams illustrating an imaging state in the first embodiment.

FIG. 5 is an explanatory diagram illustrating acquisition of a distance map during imaging according to the first embodiment.

FIGS. 6A, 6B, and 6C are diagrams illustrating influence degrees of respective illumination lights in the first embodiment.

FIGS. 7A and 7B are explanatory diagrams illustrating another imaging state in the first embodiment.

FIGS. 8A, 8B, and 8C are diagrams illustrating influence degrees of respective illumination lights in the first embodiment.

FIGS. 9A, 9B, 9C, and 9D are explanatory diagrams illustrating display states of the illumination apparatus in the first embodiment.

FIGS. 10A, 10B, and 10C are explanatory diagrams illustrating setting changes of the illumination apparatus using the image pickup apparatus according to the first embodiment.

FIG. 11 is an explanatory diagram of another imaging system according to the first embodiment.

FIGS. 12A and 12B are explanatory diagrams of an imaging system according to a second embodiment.

FIGS. 13A and 13B are explanatory diagrams of an imaging system according to a third embodiment.

FIGS. 14A and 14B are diagrams illustrating light distribution characteristics in the third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure.

### First Embodiment

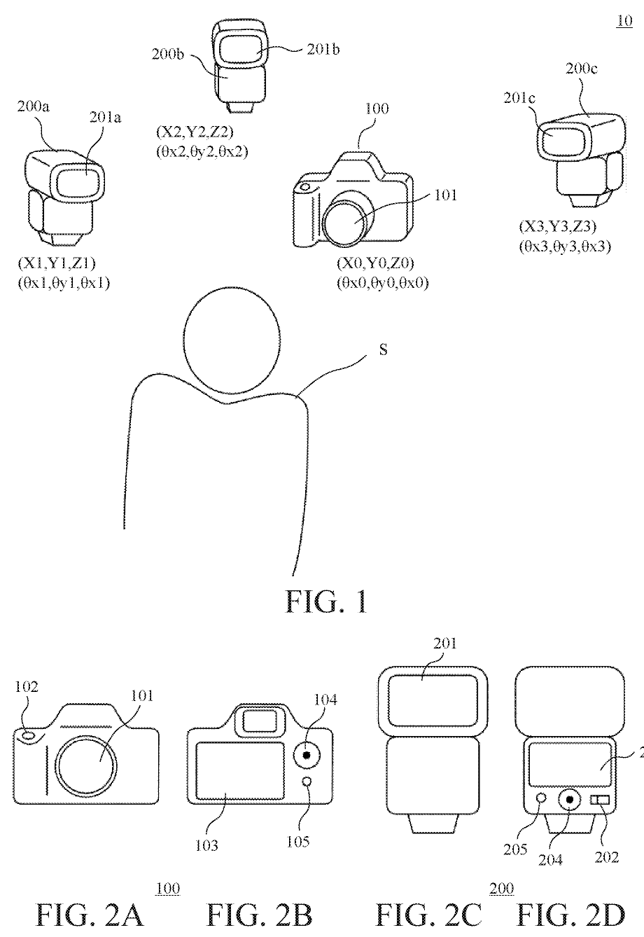

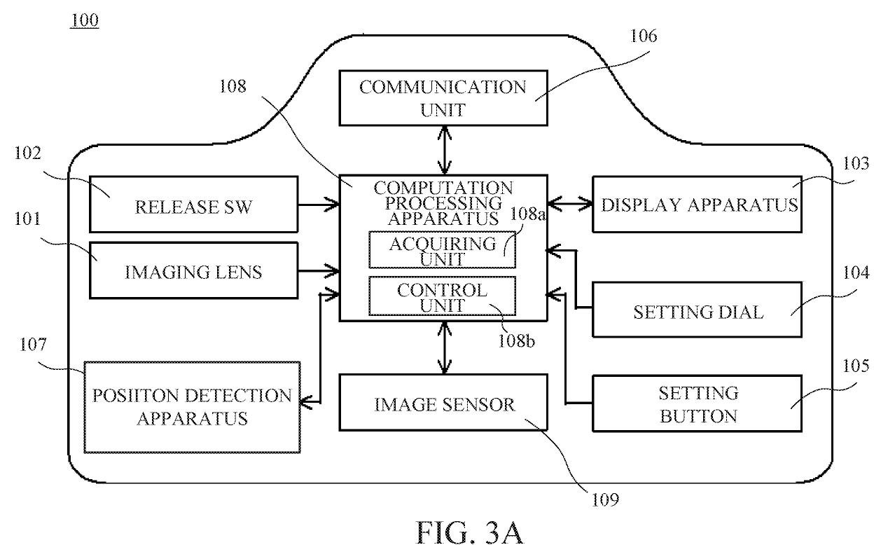

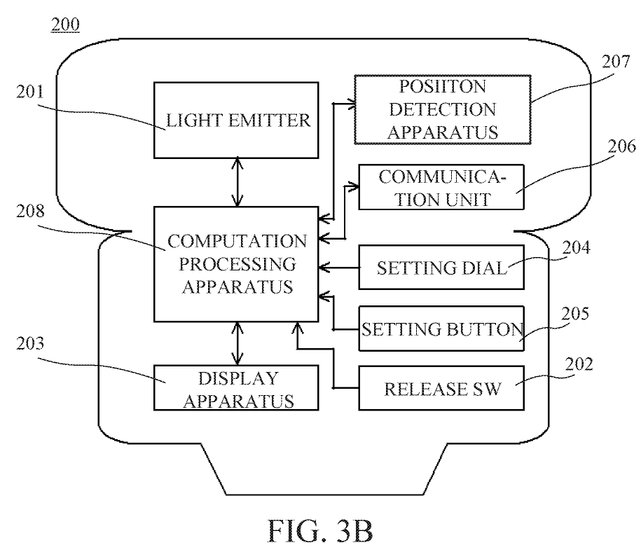

First, a first embodiment will be described. FIG. 1 is an explanatory diagram of an imaging system (illumination system) 10 according to the present embodiment. The imaging system 10 includes an image pickup apparatus 100 and a plurality of illumination apparatuses 200. In FIG. 1, the plurality of illumination apparatuses 200 include an illumination apparatus (first flash apparatus) 200a, an illumination apparatus (second flash apparatus) 200b, and an illumination apparatus (third flash apparatus) 200c. FIGS. 2A and 2B are external configuration diagrams of the image pickup apparatus 100, and FIGS. 2C and 2D are external configuration diagrams of an illumination apparatus, preferably of each illumination apparatus of the plurality of illumination apparatuses 200. FIG. 3A is a block diagram of the image pickup apparatus 100, and FIG. 3B is a block diagram of an illumination apparatus, preferably each illumination apparatus of the plurality of illumination apparatus 200.

FIG. 1 illustrates a perspective view viewed from an object S toward the image pickup apparatus 100. As illustrated in FIG. 1, an imaging lens (lens unit) 101 of the image pickup apparatus 100 is directed toward the object S, and respective light emitters 201a, 201b, and 201c of the illumination apparatuses 200a, 200b, and 200c are directed so as to irradiate the object S.

The image pickup apparatus 100 includes the imaging lens 101, a release switch (release SW) 102, a display apparatus (display unit) 103, a setting dial (operation unit) 104, and a setting button (operation unit) 105. The image pickup apparatus 100 further includes a communication unit 106, a position detection apparatus (position detector) 107, a computation processing apparatus (control apparatus) 108, and an image sensor 109.

In the image pickup apparatus 100, an image (optical image) of the object formed by the imaging lens 101 is captured (photoelectrically converted) by the image sensor 109, which serves as an imaging unit, thereby acquiring an image of the object S in response to a user operation of the release switch 102. The captured image is displayed on the display apparatus 103, and an image before imaging can also be displayed in real time (through-image display). By displaying the through-image, the user can perform imaging while checking movements of the object S and lighting conditions as appropriate. The image pickup apparatus 100 further includes the communication unit 106 for transmitting and receiving various types of information to and from peripheral devices such as the illumination apparatus 200. The communication unit 106 may use a wireless communication unit such as Wi-Fi or Bluetooth (registered trademark), or may use wired communication unit such as an accessory shoe directly electrically connected to the image pickup apparatus 100 via USB, LAN, or the like.

The computation processing apparatus 108 is a control apparatus that controls one or more illumination apparatus(es) 200 through communication. The computation processing apparatus preferably includes an acquiring unit 108a and a control unit 108b. The control apparatus may include one or more memories storing instructions, and one or more processors that, upon execution of the instructions, operate to serve as the acquiring unit 108a and the control unit 108b. As will be described later, the acquiring unit 108a acquires position information and setting information on the illumination apparatus 200, and the control unit 108b displays, on the display apparatus 103, an image processed in accordance with the position information and the setting information.

The or each illumination apparatus(es) 200 includes a light emitter 201, a power switch (power SW) 202, a display apparatus (display unit) 203, a setting dial (operation unit) 204, and a setting button (operation unit) 205. The illumination apparatus 200 may further include a communication unit 206, a position detection apparatus (position detector) 207, and an computation processing apparatus (control apparatus) 208.

When the power switch 202 of the illumination apparatus 200 is turned on, the illumination apparatus 200 may emit a predetermined light amount from the light emitter 201 upon receiving an imaging signal from the image pickup apparatus 100 (for example by pressing of the release switch 102). The computation processing apparatus (control unit) 208 may control the operation of the illumination apparatus 200. According to user operations on the setting dial 204 and the setting button 205, the computation processing apparatus 208 may change light emission characteristics (setting information) such as the light emission amount, irradiation angle, and color temperature of the light emitter 201. The computation processing apparatus 208 may display the setting information on the display apparatus 203. The illumination apparatus 200 may include the communication unit 206 and be configured to transmit and receive various types of information to and from peripheral devices such as the image pickup apparatus 100.

The image pickup apparatus 100 and the illumination apparatus 200 each may include position detection apparatuses 107 and 207 for acquiring their own position information (spatial position and spatial direction or orientation). That is to say that, one or both of the image pickup apparatus and the illumination apparatus may comprise a position detection apparatus configured to acquire position information, preferably the acquired position information is of the respective apparatus comprising the position detection apparatus. Since the image pickup apparatus 100 and the illumination apparatuses 200a, 200b, and 200c are arranged in a three-dimensional space, as illustrated in FIG. 1, each apparatus has position information indicating a spatial position (Xn, Yn, Zn) and a spatial direction (θxn, θyn, θzn).

In a case where GPS devices are provided as the position detection apparatuses 107 and 207 in the respective apparatuses, the position information is absolute position information measured by each apparatus. Thereby, the relative positions of the illumination apparatuses relative to the image pickup apparatus 100 can be calculated using differences between the position information on the illumination apparatuses 200a, 200b, and 200c and the position information on the image pickup apparatus 100. In a case where the position detection apparatuses 107 and 207 detect relative positions between the apparatuses, the relative positions relative to the image pickup apparatus 100 can be obtained by measuring relative positions between the apparatuses.

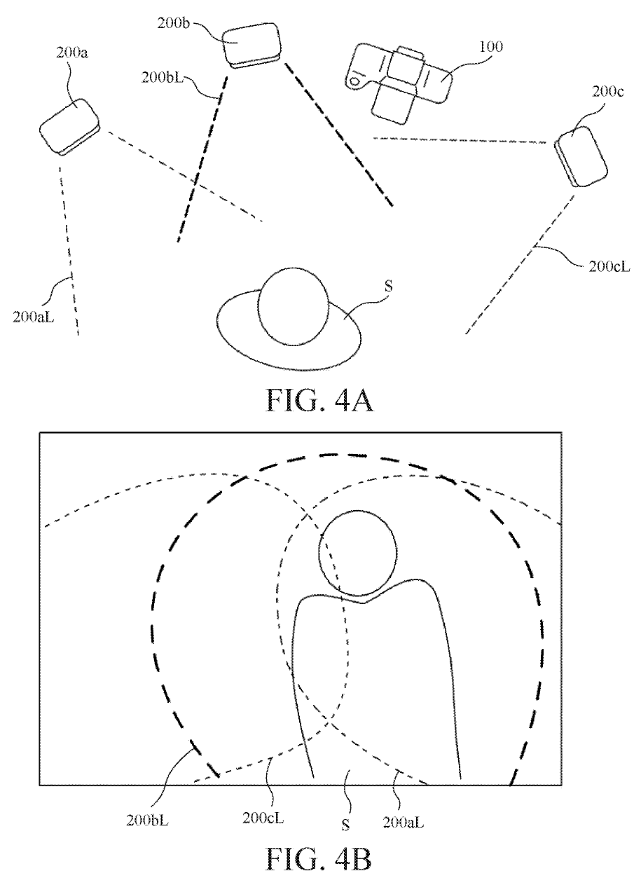

FIGS. 4A and 4B are explanatory diagrams illustrating an imaging state in the present embodiment. FIG. 4A is a top view of the imaging state illustrated in FIG. 1, illustrating that illumination effects of the illumination apparatuses 200a, 200b, and 200c on the object S are denoted by 200aL, 200bL, and 200cL, respectively. FIG. 4B is a diagram schematically illustrating the influences of the respective illumination apparatuses on an imaging screen (display surface of the display unit).

As illustrated in FIG. 4B, the illumination effects of the illumination apparatuses 200a, 200b, and 200c can be confirmed on the imaging screen when actual imaging is performed. However, in an imaging preparation stage in which a through-image is displayed on the display apparatus 103, only illumination conditions due to external light are reflected, and it is not possible to confirm what kind of image will be captured when the illumination apparatuses 200a, 200b, and 200c actually emit light. Accordingly, in order to confirm in advance what kind of image will be obtained when the illumination apparatuses 200a, 200b, and 200c emit light, a light emission simulation is performed to acquire a simulation image.

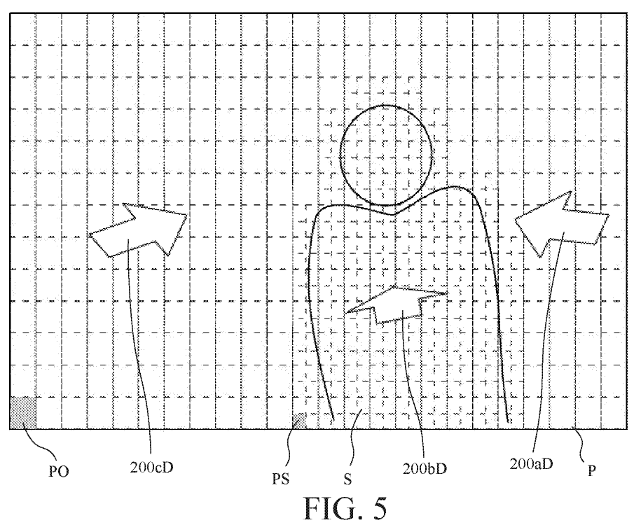

FIG. 5 is an explanatory diagram illustrating the acquisition of a distance map during imaging according to the present embodiment. First, as illustrated in FIG. 5, a portion in which the object S exists and a (background) portion in which the object S does not exist are recognized from a through-image relative to an imaging region P that is used for imaging. Then, the region is divided into a region PS in which the object S exists and a region PO that is larger than the region PS and serves as the background portion, and distance information in each region is acquired to create a distance map of the entire image. In FIG. 5, the region is divided using two types of division sizes; however, the division may be performed using multiple types of division sizes depending on circumstances, or the same division size may be used for the entire region. As the division size becomes smaller, the number of detection regions increases, which increases the time required for distance information detection and subsequent calculations; therefore, the division size may be automatically or manually changed in accordance with the processing capability of a processing apparatus that performs these operations.

Next, the image pickup apparatus 100 and the illumination apparatuses 200a, 200b, and 200c communicate position information acquired by the position detection apparatuses 107 and 207 via the communication unit 106 and 206, and calculate directions (200aD, 200bD, and 200cD) of respective irradiation lights within the imaging screen. Here, a spatial position (X0, Y0, Z0) of the image pickup apparatus 100 and a direction (θx0, θy0, θz0) in which the imaging lens 101 is oriented will be collectively referred to as an imaging direction. With respect to the imaging direction, position information on the illumination apparatus 200a is represented by a position (X1, Y1, Z1) and a direction (θx1, θy1, θz1). Similarly, with respect to the imaging direction, position information on the illumination apparatus 200b is represented by a position (X2, Y2, Z2) and a direction (θx2, θy2, θz2), and position information on the illumination apparatus 200c is represented by a position (X3, Y3, Z3) and a direction (θx3, θy3, θz3). Using the position information on the illumination apparatuses 200a, 200b, and 200c, directions of the respective irradiation lights (200aD, 200bD, and 200cD) within the imaging screen are calculated.

The image pickup apparatus 100 receives information on irradiation light, such as one or more of light emission amounts (guide numbers), irradiation angles, and color temperatures of irradiation light (information on light emission characteristics) from the illumination apparatuses 200a, 200b, and 200c. Using the information on the irradiation light, the image pickup apparatus 100 can determine from which directions illumination light is applied to the object on the imaging screen with what intensity and over what range.

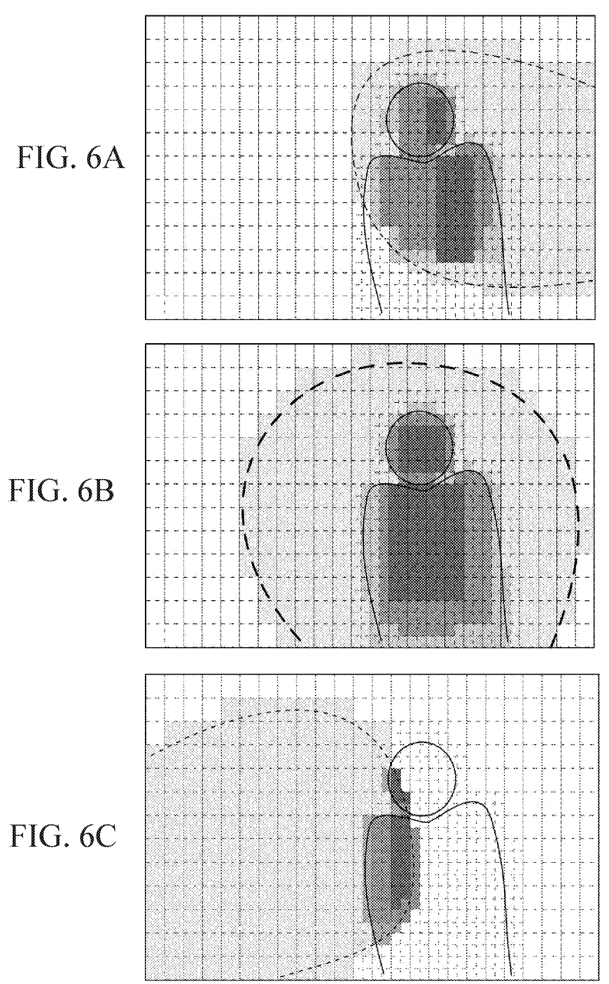

FIGS. 6A, 6B, and 6C are diagrams illustrating influence degrees of respective illumination lights. Using the calculated irradiated-light information and the distance map, the influences on the object S and the background present in each region within the screen are calculated and schematically illustrated. In FIGS. 6A, 6B, and 6C, the influence degree is indicated by density of shading, where a darker shade indicates a greater influence of illumination light (brighter). FIG. 6A illustrates the influence degree of illumination light from the illumination apparatus 200a. FIG. 6B illustrates the influence degree of illumination light from the illumination apparatus 200b. FIG. 6C illustrates the influence degree of illumination light from the illumination apparatus 200c. By adding this information to the through-image, an image in a state in which the illumination apparatuses 200a, 200b, and 200c irradiate light can be pseudo-reproduced.

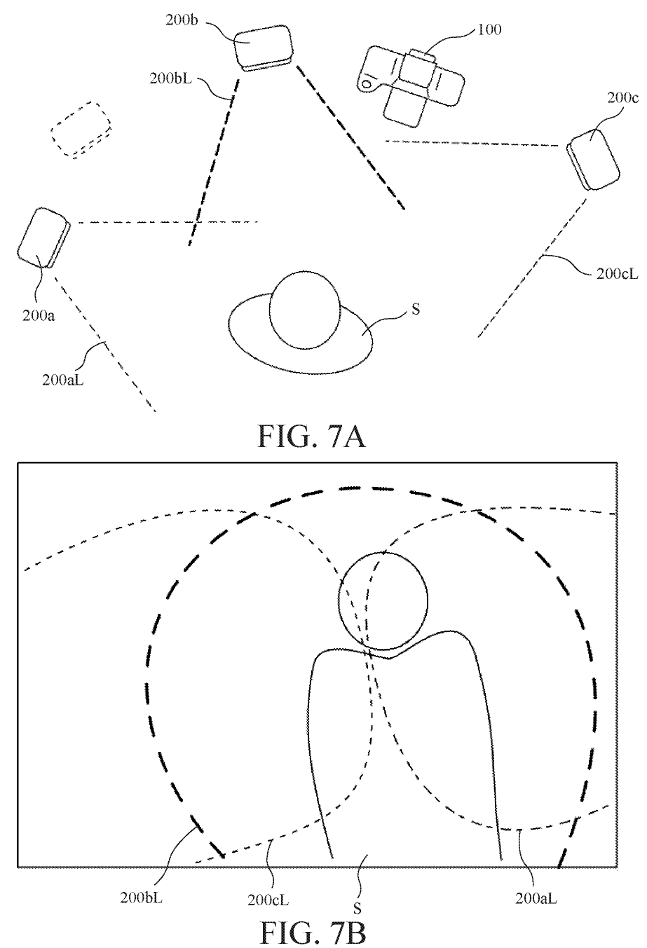

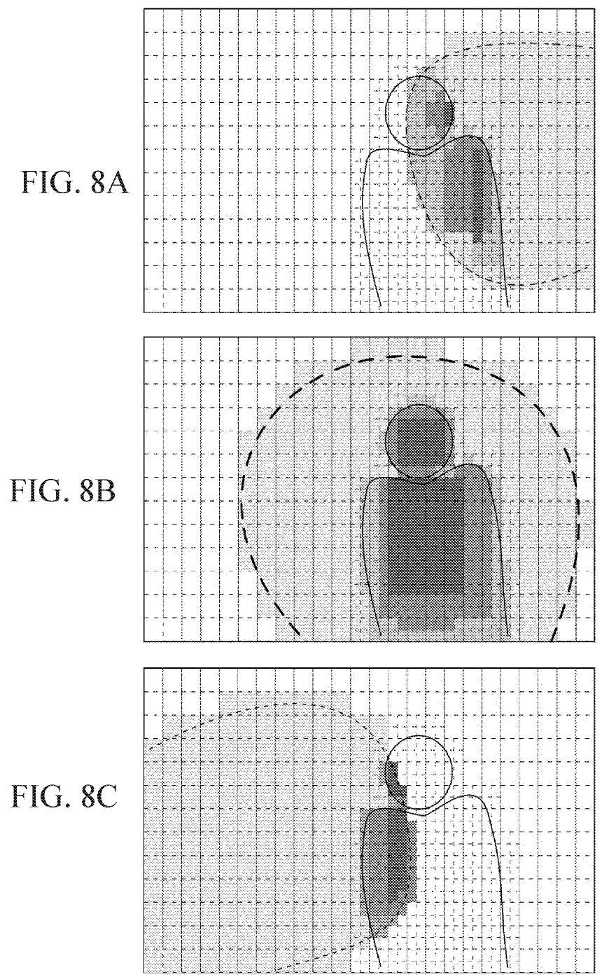

FIGS. 7A and 7B are explanatory diagrams illustrating another imaging state in the present embodiment. By confirming the through-image to which the light emission simulation described above is added, for example, when the illumination apparatus 200a is moved as illustrated in FIG. 7A, the influence of the illumination light changes and results in the influence degree as illustrated in FIG. 7B. FIGS. 8A, 8B, and 8C are diagrams illustrating the influence degrees of the illumination lights from the illumination apparatuses 200a, 200b, and 200c at this time. As illustrated in FIGS. 8B and 8C, since the positions of the illumination apparatuses 200b and 200c are not changed, their influence degrees remain the same as those illustrated in FIGS. 6B and 6C. On the other hand, by moving the illumination apparatus 200a, the manner in which illumination light is applied becomes more lateral to the object S, as illustrated in FIG. 8A.

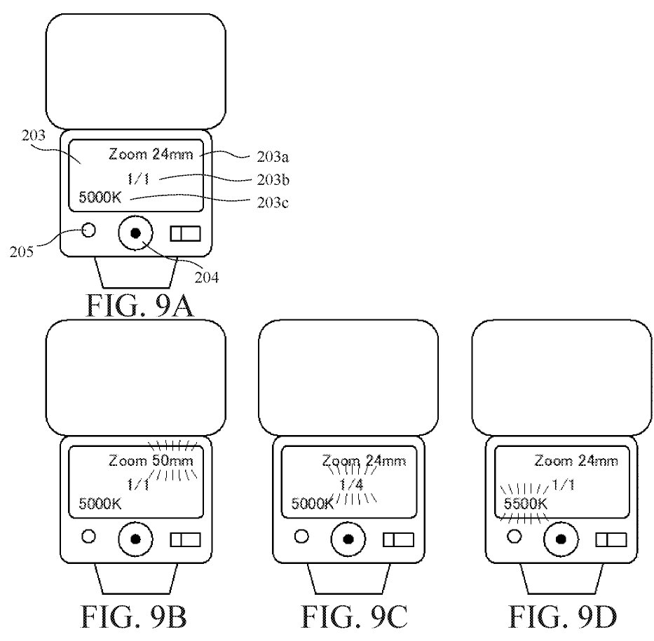

FIGS. 9A-9D are explanatory diagrams illustrating the display states of the illumination apparatus 200. As illustrated in FIGS. 9A-9D, elements that change illumination effects include electrically changeable elements such as a light emission amount or a color temperature of the illumination apparatus 200, or elements such as an auto-zoom mechanism for automatically changing an irradiation angle. These can be changed using the illumination apparatus 200. When a setting value displayed on the display apparatus 203 is to be changed by operating the setting dial 204, for example, in an attempt to change an irradiation angle, a zoom setting value display 203a is selected.

When the user presses the setting button 205, the setting enters a state in which numerical values can be changed, as illustrated in FIG. 9B, and the user rotates the setting dial 204 to change the numerical value. When the user presses the setting button 205 again, the numerical value is determined. Similarly, in an attempt to change a light emission amount, a light amount setting value display 203b is selected as illustrated in FIG. 9C. In an attempt to change a color temperature, a color temperature setting value display 203c is selected as illustrated in FIG. 9D.

The changed setting values are transmitted to the image pickup apparatus 100 when the setting button 205 is pressed and the values are determined. Alternatively, in a configuration in which change states are to be confirmed in more detail, the setting values may be transmitted to the image pickup apparatus 100 whenever the setting values are changed.

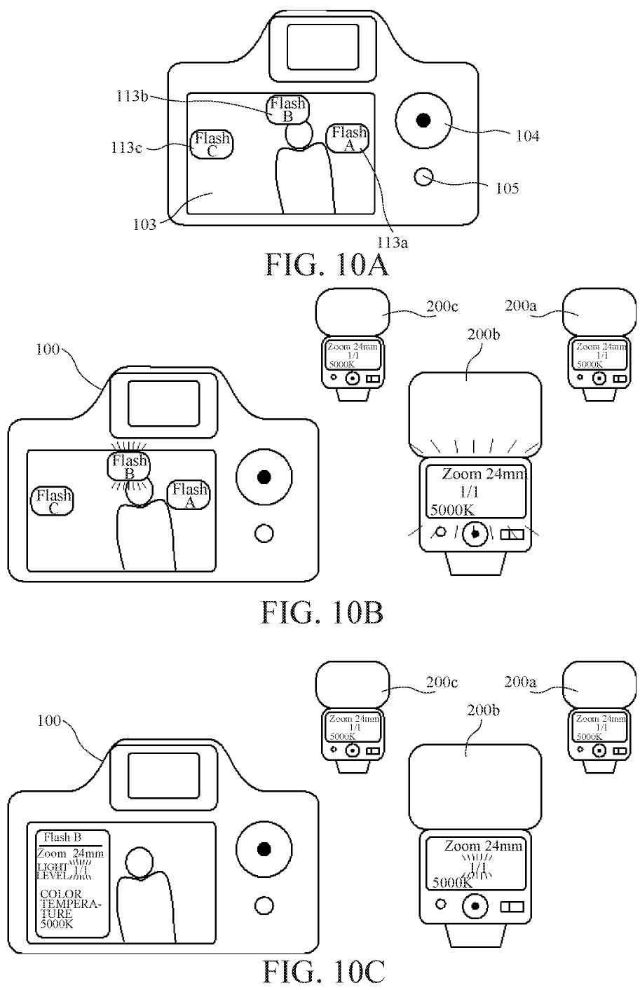

In order to change installation positions of the illumination apparatuses 200a, 200b, and 200c, each illumination apparatus is directly moved, but the setting value may be changed using the image pickup apparatus 100. FIGS. 10A, 10B, and 10C are explanatory diagrams illustrating setting changes of the illumination apparatus 200 using the image pickup apparatus 100.

As illustrated in FIG. 10A, when the setting button 105 of the image pickup apparatus 100 is pressed, the illumination apparatuses 200 that can be operated are displayed on a simulation image illustrated on the display apparatus 103. In this example, icons 113a, 113b, and 113c corresponding to the illumination apparatuses 200a, 200b, and 200c illustrated in FIG. 1 are displayed.

By operating the setting dial 104, an icon 113 for changing the set value can be selected, and in FIG. 10B, the icon 113b representing the illumination apparatus 200b is blinking to indicate a selected state. At this time, the display apparatus 203 of the illumination apparatus 200b is also blinking to indicate that it is being operated.

When the icon 113b is selected using the setting button 105, a list of setting values for the illumination apparatus 200b is displayed, as illustrated in FIG. 10C. Operating the setting dial 104 can select an item to be changed. As illustrated in FIG. 10C, when the light amount item is selected using the setting button 105, the numerical value blinks. At this time, the corresponding setting value of the illumination apparatus 200b also blinks to indicate that it is being changed.

In this state, when the setting dial 104 is operated to change the value to a desired value (such as 1/2 or 1/32) and the setting button 105 is pressed to confirm the change, the setting value is transmitted to the illumination apparatus 200b and updated.

Thus, there is a method (real-time update method) that reflects light emission influences caused by movement of the image pickup apparatus 100 or the illumination apparatus 200 or by changes in setting values, to a through-image by automatically exchanging information between the apparatuses and performing a light emission simulation each time. There is another method (manual update method) that performs a light emission simulation by transmitting change information by operating a transmission button on the apparatus that has moved or changed a setting value of the image pickup apparatus 100 or illumination apparatus 200.

The real-time update method performs a light emission simulation and displays a through-image each time an information change is confirmed, allowing illumination light influence to be confirmed instantaneously. However, since position information and setting information are repeatedly communicated and light emission simulation is performed, a large amount of information is to be processed, and a high-speed computation processing apparatus and a large-capacity memory element for temporarily storing data are used.

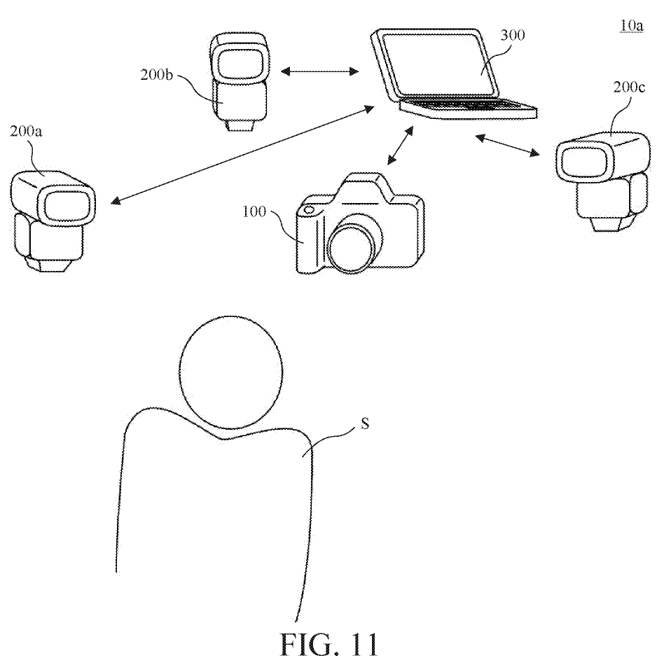

On the other hand, the manual update method does not provide the same level of convenience as the real-time update method, but may execute computation only when change information is transmitted, and thus does not require a highly advanced computation processing apparatus or memory element. Thus, in a case where processing is performed using the image pickup apparatus 100, the manual update method may be used, whereas when processing is performed by a separately provided external processing apparatus capable of high-speed computation, such as a personal computer (PC) 300 illustrated in FIG. 11, the real-time update method may be adopted. FIG. 11 is an explanatory diagram of another imaging system 10a according to the present embodiment, which is an imaging system including the PC 300.

Between the PC (control apparatus) 300 and the illumination apparatuses 200a, 200b, and 200c, position information and setting information can be transmitted and received. Transmitting a through-image together with the position information and setting information from the image pickup apparatus 100 to the PC 300 can display the through-image and a light emission simulation image on a display apparatus of the PC 300. During processing and display by the PC 300, the PC 300 may be configured to be capable of changing setting values of the illumination apparatuses 200a, 200b, and 200c, similarly to the image pickup apparatus 100.

As described above, the present embodiment enables the effects of the illumination apparatus to be recognized without actually causing the illumination apparatus to emit light and performing imaging. In the present embodiment, the image pickup apparatus 100 is an electronic camera (digital camera) and the illumination apparatus 200 is a flashlight emission apparatus, but another apparatus may be used as long as similar purposes can be achieved.

### Second Embodiment

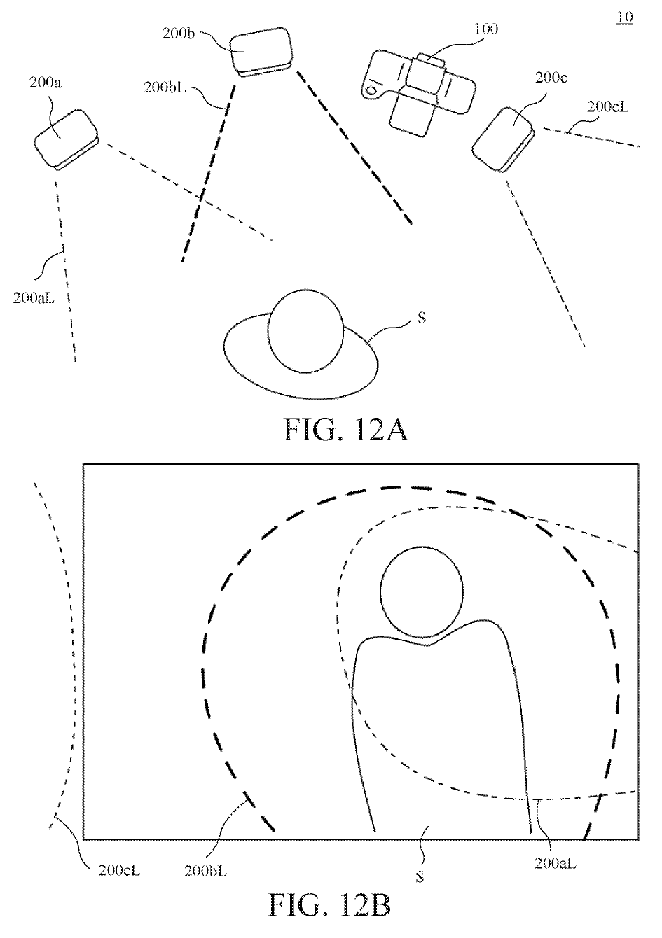

Next, a second embodiment will be described with reference to FIGS. 12A and 12B. FIGS. 12A and 12B are explanatory diagrams of an imaging system 10 according to the present embodiment. FIG. 12A is a top view illustrating an imaging state of the imaging system 10, illustrating that illumination effects of the illumination apparatuses 200a, 200b, and 200c on the object S are denoted by 200aL, 200bL, and 200cL, respectively. FIG. 12B is a diagram schematically illustrating the influences of the respective illumination apparatuses on an imaging screen.

In FIG. 12A, the illumination apparatus 200c is disposed in a direction not facing the object S. This corresponds to so-called wall-bounce imaging that irradiates reflected light using a wall or other bounce surface such as a reflector . In a case where this imaging method is used, calculation of influences on the object S requires information on the wall or other bounce surface. The information may include a position of the wall or other bounce surface (distance to the illumination apparatus 200c and distance to the object S), an angle of the wall or bounce surface, the reflection degree of the wall or other bounce surface (reflectance or transmittance of the wall or other bounce surface), and a color of the wall or other bounce surface, in addition to information on the apparatus to be used. Thus, the image pickup apparatus 100 or the illumination apparatus 200 may have functions for measuring them. These functions and the calculations are complicated, and the processing load increases.

Therefore, although imaging in the installed state illustrated in FIG. 12A may be possible, it is determined to be unsuitable for light emission simulation in the present embodiment. In such a case, the illumination apparatus 200c is unnecessary as an illumination light source. Since causing the illumination apparatus 200c to emit light may have an unintended influence on a captured image, the setting is automatically changed so that the illumination apparatus 200c does not emit light (light emission of the illumination apparatus 200c is stopped). Image processing may be performed by excluding the illumination apparatus 200c from processing as a light source for light emission simulation. Even if the light emission amount set for the illumination apparatus 200c is too small to actually reach the object S, a similar restriction is imposed, thereby efficiently conducting light emission simulation. In a case where the control unit 108b determines that a value indicating an illumination effect of any illumination apparatus is smaller than a predetermined value, the control unit 108b stops light emission of that illumination apparatus and does not add an illumination effect of that illumination apparatus to an image captured by the image sensor 109.

The imaging state illustrated in FIG. 12A is not intentional, and the illumination apparatus 200c may have been disposed with the intention of illuminating the object S but fails to do so due to improper positioning, or a light emission amount may have been set with the intention of providing sufficient illumination but is actually too small. In such cases, forcibly performing the above processing may cause a misunderstanding that the illumination apparatus 200c is malfunctioning. To avoid this, a warning (alert) such as “Please change the position of Flash C” or “Please increase the light emission amount of Flash C” may be displayed on the display apparatus 103 of the image pickup apparatus 100 to prompt correct imaging. Instead of the warning display, another warning unit such as an audible alarm may be used.

In any of these methods, determination can be made based on directions in which the illumination apparatuses 200a, 200b, and 200c face with respect to the imaging direction of the image pickup apparatus 100, and on setting values of the illumination apparatuses 200a, 200b, and 200c relative to distance information on the screen. Thus, determination can be easily made during the communication of position information and setting value information. Therefore, since it is possible to make a determination before conducting the light emission simulation, the processing speed can be improved by excluding an unsuitable illumination apparatus from the light emission simulation in advance.

### Third Embodiment

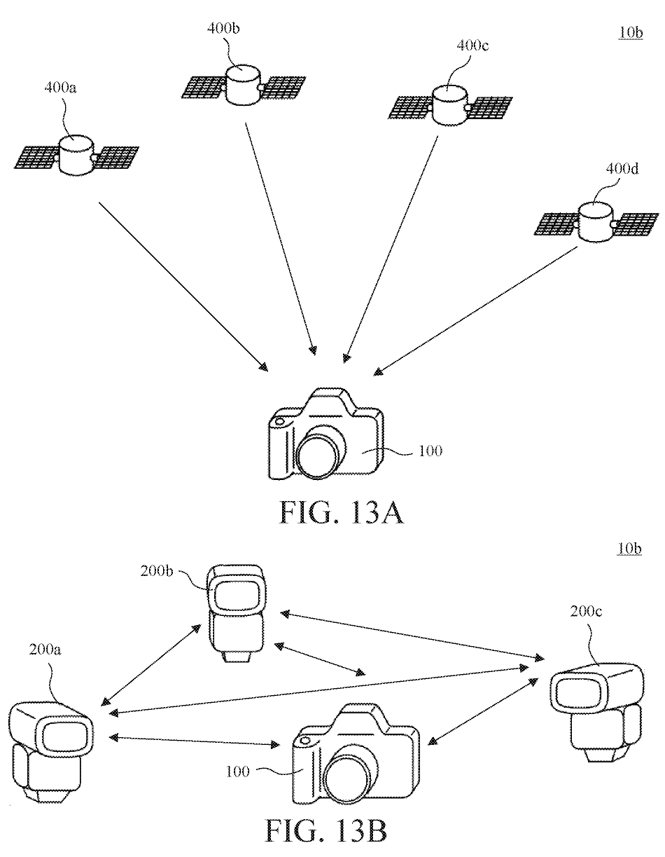

Next, a third embodiment will be described with reference to FIGS. 13A and 13B. FIGS. 13A and 13B are explanatory diagrams of an imaging system (illumination system) 10b according to the present embodiment. FIG. 13A schematically illustrates a position measuring method using GPS as the position detection apparatuses 107 and 207 provided in the image pickup apparatus 100 and the illumination apparatus 200, respectively (although only the image pickup apparatus 100 is simply illustrated). To obtain position information on an object in the three-dimensional space, information from three objects (satellites 400a, 400b, and 400c) is sufficient. The GPS position measurement uses information from an additional satellite 400d to correct temporal errors. Thus, information from four satellites 400a, 400b, 400c, and 400d is required in the present embodiment. If information from five or more satellites 400 can be captured, those pieces of information can be used for correction, and thus the accuracy can be improved.

FIG. 13B illustrates a method of measuring relative information between apparatuses as the position detection apparatuses 107 and 207 provided in the image pickup apparatus 100 and the illumination apparatus 200, respectively. The image pickup apparatus 100 and the illumination apparatuses 200a, 200b, and 200c include communication units 106 and 206 for transmitting information, but there is a method that detects distances and directions to communication counterparts using radio waves during communication. In this case, since information from three objects is required as described above, connections among four apparatuses are necessary as illustrated in FIG. 13B. When fewer apparatuses are connected, a method of obtaining an absolute position for each apparatus using GPS or the like is required.

In any of these methods, if the number of devices (satellites or connected apparatuses) used to obtain position information is small, errors may occur in the position information, and the errors may not be correctly reflected in the light emission simulation. Accordingly, the present embodiment changes light emission characteristics in the light emission simulation in accordance with a degree of error in position information relative to the actual light emission characteristics of the illumination apparatus 200.

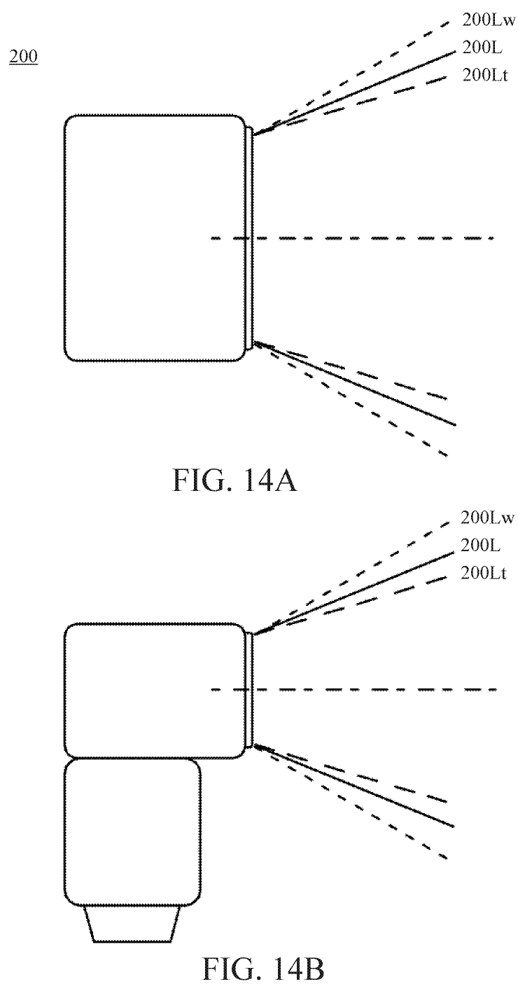

FIGS. 14A and 14B are diagrams illustrating light distribution characteristics in the present embodiment. FIG. 14A is a top view of the illumination apparatus 200, and FIG. 14B is a side view of the illumination apparatus 200. An irradiation range during light emission of the illumination apparatus 200 is originally indicated by 200L (solid line). In an attempt to allow a large tolerance for errors in the position information, a light distribution characteristic (irradiation range) used for the light emission simulation is changed so as to expand from the irradiation range 200L to an irradiation range 200Lw. Thereby, even when the position information on the illumination apparatus 200 is slightly deviated from an actual position, light emission simulation with reduced error can be performed.

In a case where a warning that an object is not correctly illuminated is issued as described in the second embodiment, or in a case where excluding conditions of an illumination light source are made stricter, determination is made using a reduced irradiation range, such as changing from the irradiation range 200L to an irradiation range 200Lt. This enables accurate alignment of irradiation directions. In a case where the accuracy of the position information is low, it may be determined that a correct light emission simulation cannot be performed, and light emission simulation may be disabled.

As described above, in each embodiment, a control apparatus (computation processing apparatus 108) may include an acquiring unit 108a and a control unit 108b. The acquiring unit 108a may be configured to acquire, via communication, preferably through a communication unit or other communication means, position information and setting information on one or more illumination apparatuses 200 (200a, 200b, and 200c). The control unit 108bis configured to display, on a display unit, an image processed in accordance with the position information and the setting information on the illumination apparatus or respective illumination apparatuses. The image processed in accordance with the position information and the setting information may be an image comprising a simulated influence of illumination to be provided by the or each illumination apparatus. That is to say, the image processed shows an expected influence of illumination which will be provided by the or each illumination apparatus.

The acquiring unit 108a may have a function as an image acquiring unit that acquires an image captured by the image pickup apparatus 100, and the control unit 108b may display, as the image, an image obtained by applying illumination effects corresponding to the position information and the setting information to the captured image on the display unit. The position information may be information indicating a position and a direction of the illumination apparatus detected by a position detector. The position information may be information on a relative position of the illumination apparatus 200 relative to the image pickup apparatus 100. The setting information may be information on light emission characteristics of the illumination apparatus 200. The light emission characteristics may include at least one of a light emission amount, an irradiation angle, and a color temperature of the illumination apparatus 200.

In a case where at least one of the position information and the setting information on the illumination apparatus 200 is changed, the control unit 108b may update the image displayed on the display unit. The acquiring unit 108a may acquire the position information and the setting information in accordance with a user operation. The acquiring unit 108a may periodically acquire the position information and the setting information. For example, the acquiring unit 108a may acquire the position information and the setting information each time a predetermined time period elapses.

The acquiring unit 108a may acquire distance information on an object (or subject within the image), and the control unit 108b may display, on the display unit, an image processed in accordance with the distance information. The acquiring unit 108a may use different region sizes (division sizes) for acquiring the distance information between a first portion determined to correspond to a main object and a second portion different from the first portion in a display surface (imaging screen) of the display unit.

In a case where the control unit 108b determines that a value indicating an illumination effect is smaller than a predetermined value, the control unit 108b may stop light emission of the illumination apparatus 200 and does not apply the illumination effect to an image captured by the image sensor 109. In a case where the control unit 108b determines that the value indicating the illumination effect is smaller than the predetermined value, the control unit 108b may issue a warning.

The control unit 108b may change the light emission characteristics of the illumination apparatus 200 used for the calculation of illumination effects according to the accuracy of the position information so as to differ from the actual light emission characteristics of the illumination apparatus 200. In a case where the control unit 108b determines that the accuracy of the position information is lower than a predetermined value, the control unit 108b may not apply an illumination effect to an image captured by the image sensor 109. The control unit 108b may display information about the illumination apparatus 200 on the display unit, and change the setting information on the illumination apparatus 200 when the information displayed on the display unit is changed by a user operation.

In each embodiment, at least a part of the functions of the computation processing apparatus 108 of the image pickup apparatus 100 may be provided in the computation processing apparatus 208 of the illumination apparatus 200. For example, at least a part of the functions of the acquiring unit 108a and the control unit 108b of the computation processing apparatus 108 may be provided in the computation processing apparatus 208. Alternatively, at least a part of the functions of the computation processing apparatus 208 may be provided in the computation processing apparatus 108.

Each embodiment can provide a control apparatus, an image pickup apparatus, an illumination system, a control method, and a storage medium, each of which can easily and properly set an illumination apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-071038, filed on Apr. 23, 2025, which is hereby incorporated by reference herein in its entirety.

What is claimed is:

1. A control apparatus for controlling an illumination apparatus by communication and for displaying an image, the control apparatus comprising:
one or more memories storing instructions; and
one or more processors that, upon execution of the instructions, operate to:
acquire position information and setting information of the illumination apparatus via communication, and
display, on a display unit, an image processed in accordance with the position information and the setting information.

2. The control apparatus according to claim 1, wherein the one or more processors operate to:
acquire an image captured by an image pickup apparatus,
display, as the image on the display unit, an image obtained by applying an illumination effect corresponding to the position information and the setting information to the captured image.

3. The control apparatus according to claim 1, wherein the position information includes information indicating a position and a direction of the illumination apparatus.

4. The control apparatus according to claim 3, wherein the information indicating a position and a direction of the illumination is detected by a position detector.

5. The control apparatus according to claim 3, wherein, in a case where the one or more processors determine that accuracy of the position information is lower than a predetermined value, the one or more processors operate not to apply an illumination effect corresponding to the position information and the setting information of the illumination apparatus to an image captured by an image sensor.

6. The control apparatus according to claim 1, wherein the position information includes information on a relative position of the illumination apparatus relative to an image pickup apparatus.

7. The control apparatus according to claim 1, wherein the setting information includes information on a light emission characteristic of the illumination apparatus.

8. The control apparatus according to claim 7, wherein the light emission characteristic includes at least one of a light emission amount, an irradiation angle, and a color temperature.

9. The control apparatus according to claim 1, wherein the one or more processors operate to update the image displayed on the display unit in a case where at least one of the position information and the setting information of the illumination apparatus has been changed.

10. The control apparatus according to claim 1, wherein the one or more processors operate to acquire the position information and the setting information in accordance with a user operation.

11. The control apparatus according to claim 1, wherein the one or more processors operate to periodically acquire the position information and the setting information.

12. The control apparatus according to claim 1, wherein the one or more processors operate to:
acquire distance information on an object, and
display, on the display unit, the image processed in accordance with the distance information.

13. The control apparatus according to claim 12, wherein the one or more processors operate to:
use a plurality of regions for acquiring distance information, and
use different region sizes between a first portion determined to correspond to a main object and a second portion different from the first portion.

14. The control apparatus according to claim 1, wherein, in a case where the one or more processors determine that a value indicating an illumination effect corresponding to the position information and the setting information of the illumination apparatus is smaller than a predetermined value, the one or more processors operate to stop light emission of the illumination apparatus and not to apply the illumination effect to an image captured by an image sensor.

15. The control apparatus according to claim 1, wherein, in a case where the one or more processors determine that a value indicating an illumination effect corresponding to the position information and the setting information of the illumination apparatus is smaller than a predetermined value, the one or more processors operate to issue a warning.

16. The control apparatus according to claim 1, wherein the setting information includes information on a light emission characteristic of the illumination apparatus, and
wherein the one or more processors operate to change, in accordance with accuracy of the position information, the light emission characteristic of the illumination apparatus used for calculation of an illumination effect so as to differ from an actual light emission characteristic of the illumination apparatus.

17. The control apparatus according to claim 1, wherein the one or more processors operate to:
display information about the illumination apparatus on the display unit, and
change the setting information of the illumination apparatus when the information displayed on the display unit is changed by a user operation.

18. An image pickup apparatus comprising:
an image sensor configured to capture an image;
one or more memories storing instructions; and
one or more processors that, upon execution of the instructions, operate to:
acquire position information and setting information of an illumination apparatus by communicating with the illumination apparatus; and
display, on a display unit, an image processed in accordance with the position information and the setting information.

19. An illumination system comprising:
the control apparatus according to claim 1; and
one or more illumination apparatuses.

20. A control method for controlling an illumination apparatus by communication, the control method comprising:
acquiring position information and setting information of the illumination apparatus via communication; and
displaying, on a display unit, an image processed in accordance with the position information and the setting information.

21. A non-transitory computer-readable storage medium storing a program that causes a computer to execute the control method according to claim 20.
